(19) United States
(12) Patent Application Publication
(10) Pub. No.: US 2011/0082002 A1
(43) Pub. Date: Apr. 7, 2011

(54) Continuously Variable Rear Axle

(75) Inventors: Stephen Heath, Fort Wayne, IN (US); Thomas Burkholder, New Haven, IN (US)

(73) Assignee: International Truck Intellectual Property Company, LLC, Warrenville, IL (US)

(21) Appl. No.: 12/573,922

(22) Filed: Oct. 6, 2009

(51) Int. Cl. F16H 37/08; F16H 55/56

(52) U.S. Cl. 475/198; 474/8

(57) ABSTRACT

A continuously variable rear axle allows for increasing the number of rear axle ratios, and thereby further allowing low drive ratios for high speed, low torque applications, and high ratios for low speed, high torque situations utilizing otherwise industry standard transmissions.

### BACKGROUND

1. Technical Field

The disclosure relates to motor vehicle powertrains and more particularly to multi-speed rear-axles.

2. Description of the Problem

Motor vehicle engineers optimize powertrain performance of rear wheel drive heavy and medium duty trucks and busses in a number of ways, including by managing transmission to rear axle drive ratios depending upon the specific application a vehicle is put to (this is often referred to as a vehicle's vocation). Ratios are selected to achieve appropriate wheel and vehicle speed. The selection of rear axle/differential ratios, based upon industry standard transmission offerings, may optimize vehicle acceleration, launchability and gradeability, while compromising fuel economy. For Class 8 over-the-road vehicles, powertrain specifications may compromise acceleration and gradeability using low axle ratios, that are specified at supplier-set increments, for the sake of better fuel economy. The problem to be solved is to provide the correct rear axle ratio on a vehicle as a function of the operational state to better meet a broader set of performance objectives.

Powertrain performance and fuel economy have historically been managed by controlling N/V (RPM/vehicle speed) for a given engine, transmission and vehicle. Engineers prepare performance calculations using engine speed, transmission ratios and shift points, rear axle ratio, and tire size to generate integrated performance curves. Based upon these curves and market preferences, vocational design platform targets are set for key performance attributes, such as the competing characteristics of acceleration or fuel efficiency, and resultant values of the alternatives are recorded and mitigated by changing tires, aerodynamic equipment, or light weight design features. In some applications, two speed rear axles and additional overdrive transmissions have been developed to provide low ratios in order to provide an added fuel economy or torque option. Two speed rear axles have most commonly been found on vehicles which are used both for highway service, where fuel economy is critical, and off highway service where torque is demanded.

### SUMMARY

In its preferred form, a motor vehicle is provided with a continuously variable rear axle which allows for increasing the number of rear axle ratios, and thereby further allowing low drive ratios for high speed, low torque applications, and high ratios for low speed, high torque situations. By using a continuously variable rear axle, ratios can be changed at small increments to provide a wide range of ratios, controllable by the operator or vehicle controller according to performance requirements. This device allows change in performance without changing gears that traditionally is required to change a rear axle ratio. The technology employed is similar to that used in continuously variable transmissions (CVT) with the preferred form of CVT being one which utilizes a belt riding on pulleys formed between variably spaced conical plates.

Additional effects, features and advantages will be apparent in the written description that follows.

### BRIEF DESCRIPTION OF THE DRAWINGS

The contribution to the art believed novel is set forth in the appended claims. The preferred mode of use will best be understood by reference to the following detailed description of an illustrative embodiment when read in conjunction with the accompanying drawings, wherein:

FIG. 1 is side elevation of a type of truck use of a preferred embodiment of the invention would be advantageous with.

FIG. 2 is a plan view of a vehicle frame incorporating a exemplary drive train and associated control elements of the vehicle control system.

FIG. 3 is a schematic of a control system for the vehicle of FIG. 1.

FIG. 4 is a schematic illustration of a conical plate continuously variable power transmission for a rear differential.

### DETAILED DESCRIPTION OF AN EXEMPLARY EMBODIMENT

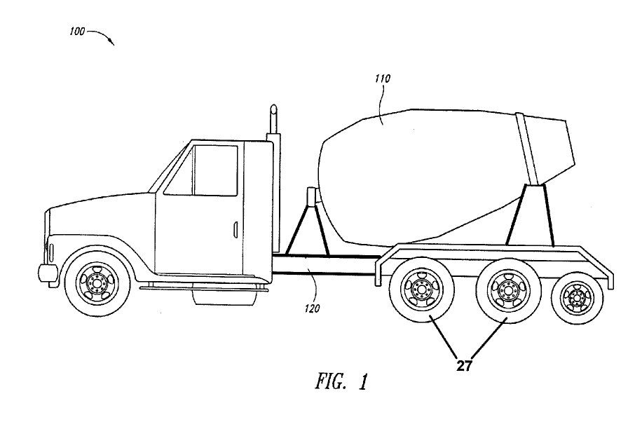

Referring now to the drawings and in particular to FIG. 1, a vehicle 100 carrying a cement mixer 110 mounted to a chassis 120 is shown. Vehicle 100 is conventionally a rear wheel drive vehicle with drive wheels 27 located under the aft part of the chassis 120. A cement mixer 110 equipped vehicle 100 is shown simply to illustrate a class of vehicle which is routinely used in on and off road situations, and which could advantageously utilize low final drive ratio rear axles for highway situations to economize on fuel consumption and high final drive ratio axles to supply high torque to the drive wheels 27 when the vehicle is loaded and is utilized off highway to reach a construction site. Embodiments of the present application are by no means limited to a vehicle vocation of cement mixing. The cement mixer vocation is intended only as an example. While the present application is intended for use with rear axles it is not necessarily limited to applications where the vehicles are exclusively rear wheel drive. For example, vehicles have been built which utilize on demand four wheel drive, and where a lower final drive ratio is used with the rear axle in two wheel drive mode and a higher ratio is used with the rear axle in four wheel drive mode.

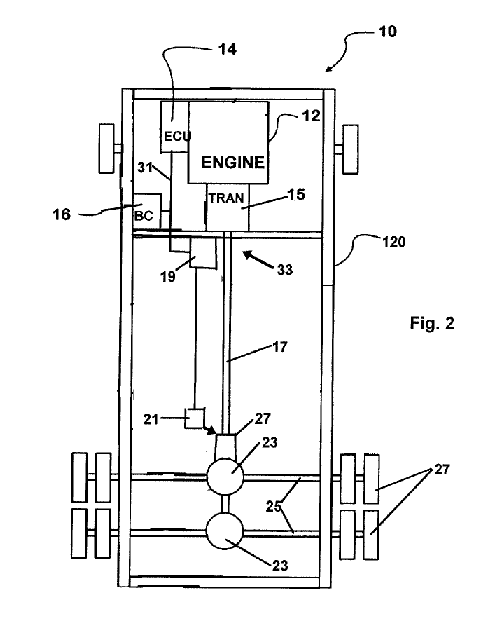

FIG. 2 is a plan view of a vehicle chassis 10 built on a conventional box frame 120 and a powertrain 33. Powertrain 33 includes an engine 12 which delivers power to a transmission 15 and from the transmission along a drive shaft 17 to the rear drive axles 25 which include rear differentials 23. Differentials 23 provide final drive ratios. A CVT 27 is located forward from forward differential 23 allowing varying the effective drive ratio of the differentials 23. A ratio selector unit 21 under the control of the transmission controller 19 provides for positioning working components of the CVT 27. Depending upon the layout of the differentials the ratio selector may need only operate on a CVT for the front differential 23. Each rear drive axle 25 has on set of rear drive wheels 27. It is possible to integrate the CVT 27 with a rear differential as well. Either form may be considered a continuously variable rear axle.

Three major controllers are typically involved in implementing the embodiment, a transmission controller 19, an engine controller 14 and a body computer 16. The three controllers communicate with one another over a controller area network (CAN) bus 31. The drive ratio selection mechanism 21 is illustrated as under the control of transmission controller 19.

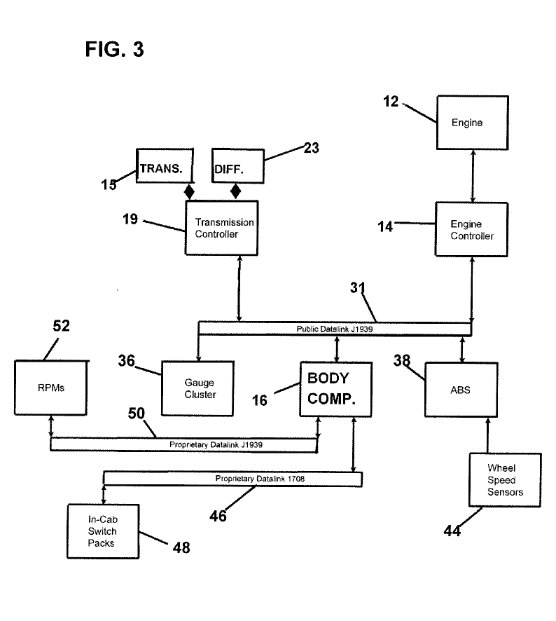

FIG. 3 illustrates the vehicle control system in greater detail. The principal elements of the control system include the engine controller 14, the body computer 16 and the transmission controller 19. Other systems may be peripherally involved in the control scheme. For example, the system for controlling selection of rear axle drive ratios may be either manual or automatic. If manual selection of the ratio may be made over switches attached to the gauge cluster 36 or in-cab switches 48, the status of which is communicated to the body computer 16 over an SAE J1708 compliant bus 46. The demands of power take off equipment under the control of remote power modules 52 may limit the power available from engine 12 and thus affect selection of a drive ratio due to limits of available power. Status reports concerning remote power modules 52 indicating operation of power takeoff equipment such as a cement mixer, occur over a datalink 46. Vehicle speed may affect choice of drive ratios. Vehicle speed may be measured by wheel speed sensors 44 communicating with an antilock brake controller 38 or may be supplied by the transmission controller using a tachometer mounted to the transmission 15. If vehicle speed is determined from a transmission tachometer the transmission controller 19 necessarily refers to the selected gear and the final axle drive ratio to determine vehicle speed.

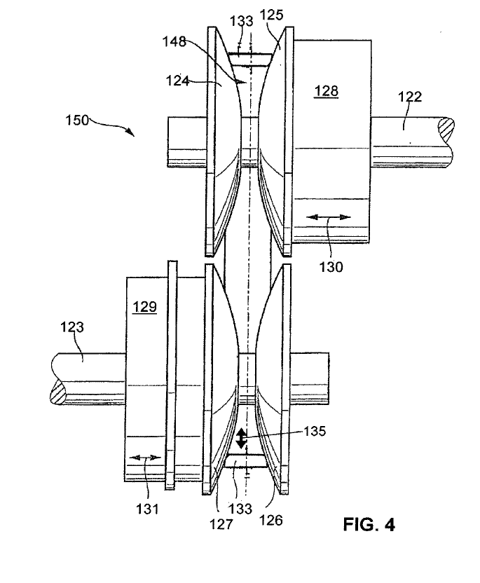

FIG. 4 illustrates a preferred continuously variable transmission linkage (CVTL) 150. CVTL 150 is a belt 133 driven device, with the belt 133 riding on what are, in effect, two variable-diameter pulleys 128, 129. The power transmission surfaces operated on by belt 133 for pulleys 128, 129 are formed between conical plates. Conical plates 125 and 148 form the power transmission surfaces of pulley 128 and conical plates 126 and 127 form the power transmission surfaces of pulley 129. The effective diameter of the working surfaces of the pulleys 128, 129 is varied by varying the distance of the conical plates from one another. For pulley 128 conical plate 125 may be moved in and out as indicated by double headed arrow 130 to vary its distance from a positionally fixed conical plate 124. For pulley 129 conical plate 127 is moved back and forth as indicated by double headed arrow 131 to vary its distance from positionally fixed plate 126.

Plates 127 and 125 are opposed (though on separate rotational axes) and move synchronously in the same direction so that the spacing between plates 127 and 126 narrows at the same time that the spacing between plates 124 and 125 opens and vice versa. Belt 133 rides inwardly on one set of plates and outwardly on the other pair of plates relative to the respective axes of rotation of pulleys 129 and 130 on shafts 123 and 122 as plates 127 and 125 move (as indicated by double arrow 135 with respect to shaft 123 for pulley 129). This keeps belt 133 under tension as the path length followed by the belt around the pulleys is constant. Taking shaft 123 to be the power input shaft belt 133 moves inwardly on the axis of rotation for shaft 123 to raise the drive ratio to increase available torque for acceleration and launching and outwardly to lower the drive ratio and improve fuel economy. Where input shaft 123 corresponds to drive shaft 17 only one CVLT 150 need be provided per vehicle with output shaft 122 supplying power to differentials 23 for as many rear drive axles as are present on a vehicle.

Current rear axles for commercial trucks and buses are available with a single ratio or with a 2-speed shiftable option between mechanical gears. Utilizing the present teachings, rear axle ratios can be changed based upon operator input to provide ideal acceleration, launchability, or gradeability based upon axle ratio selection, and ideal fuel economy performance in over-the-road applications without changing rear differentials within the rear axle assembly. For vehicle with industry standard transmissions, this creates a means to optimize speed and reduce engine speed, thus saving fuel. Determination of the ideal ratio may be dependent upon a number of factors, including factors used to predict likely power demand and availability. Power available may be affected by height above sea level and thus air pressure may be used as in input in an automatic system for selecting ratios. A manual override can be used to provide the driver with the capability of setting the system for high torque demands. All of these features are met while retaining industry standard transmissions and rear end differentials.

While only a preferred embodiment is described here in detail, the claims are not limited thereto, but are intended to extend to various changes and modifications thereof.

What is claimed is:

1. A motor vehicle power train comprising:
an engine;
a transmission;
an output shaft from the transmission;
at least a first set of rear drive wheels; and
a continuously variable transmission linkage coupling the output shaft to the rear drive wheels.

2. A motor vehicle power train according to claim 1, the continuously variable transmission linkage further comprising:
at least a first set of opposed, spaced conical plates, the spacing between which can be varied; and
a belt drive riding on the opposed, spaced conical plates.

3. A motor vehicle power train according to claim 2, further comprising:
a control system including at least an engine controller and a transmission controller programmed for selecting a drive ratio for the continuously variable transmission linkage based on engine and transmission operating variables.

4. A motor vehicle power train according to claim 3, further comprising:
the control system allowing operator selection of the drive ratio of the continuously variable transmission linkage.

5. A motor vehicle power train according to claim 4, further comprising:
a plurality of rear differentials and a plurality of rear drive wheel sets with the continuously variable transmission linkage connecting the output shaft to at least a first differential.

6. A motor vehicle drive axle comprising:
a set of rear drive wheels;
a differential; and
a continuously variable transmission linkage for coupling an output shaft from a transmission to the differential.

7. A motor vehicle drive axle according to claim 6, further comprising:
a control system responsive to available power on the output shaft for selecting a drive ratio for the continuously variable transmission linkage.

8. A motor vehicle drive axle according to claim 6, further comprising:
a control system responsive to operator input for selecting a drive ratio for the continuously variable transmission linkage.

9. A motor vehicle drive axle according to claim 7, the continuously variable transmission linkage further comprising at least a first pulley including opposed, variably spaced conical plates.

10. A motor vehicle drive axle according to claim 9, the drive axle being a rear drive axle.
